(19) United States
(12) Patent Application Publication
(10) Pub. No.: US 2012/0006699 A1
(43) Pub. Date: Jan. 12, 2012

(54) Modularly Built Container for Cooked Food Preparations

(75) Inventors: Achim Hofmann, Rimbach (DE); Julia Jebsen, Hildesheim (DE)

(73) Assignee: TICONA GMBH, Kelsterbach (DE)

(21) Appl. No.: 13/125,379

(22) PCT Filed: Oct. 21, 2009
(86) PCT No.: PCT/EP2009/063807

§ 371 Date: Sep. 26, 2011

(30) Foreign Application Priority Data
Oct. 23, 2008 (DE) 102008052935.4

(51) Int. Cl. B65D 77/00; B29C 47/02; B29C 49/00

(52) U.S. Cl. 206/216; 264/523; 156/245

(57) ABSTRACT

The invention relates to a modular container for the preparation of foods, in particular baked goods, by cooking, comprising a self-supporting base plate (1) having an extension in one plane, and limiting elements (4, 5, 6) which project from the plane and which are detachably connected to the base plate (1).

The present application is the U.S. Nationalization of PCT Published Patent Application No. PCT/EP2009/063807 having International Publication No. WO 2010/046397 and having a filing date of Oct. 21, 2009, which claims priority to German Patent Application No. 102008052935.4 having a filing date of Oct. 23, 2008, and claims filing benefit of U.S. Provisional Patent Application Ser. No. 61/144,945 having a filing date of Jan. 15, 2009.

The present invention relates to a container having a modular design, i.e., constructed of multiple components which are detachably connected to one another, for the preparation of foods, in particular baked goods, by cooking.

For any conceivable type of food, in particular baked goods, there are individualized pans for the preparation thereof, in particular baking pans, whose particular geometric shapes, however, are generally predefined. However, storage of numerous such pans having various geometric shapes results in space problems in the household, which is of considerable importance in everyday life.

As partially variable pans, springform pans made of metal are known, which in special embodiments have inserts with different shapes or patterns.

However, there is a need for a new pan which for the first time allows foods to be shaped with the greatest possible variety, and at the same time has only minimal space requirements for storage and is composed of only a few individual components.

The object, therefore, is to develop a container for the preparation of foods whose shape may be varied, which is composed of only a few individual parts, and which can be manufactured economically with little technical complexity.

The invention is explained below in greater detail for one skilled in the art by way of example, with reference to the drawings.

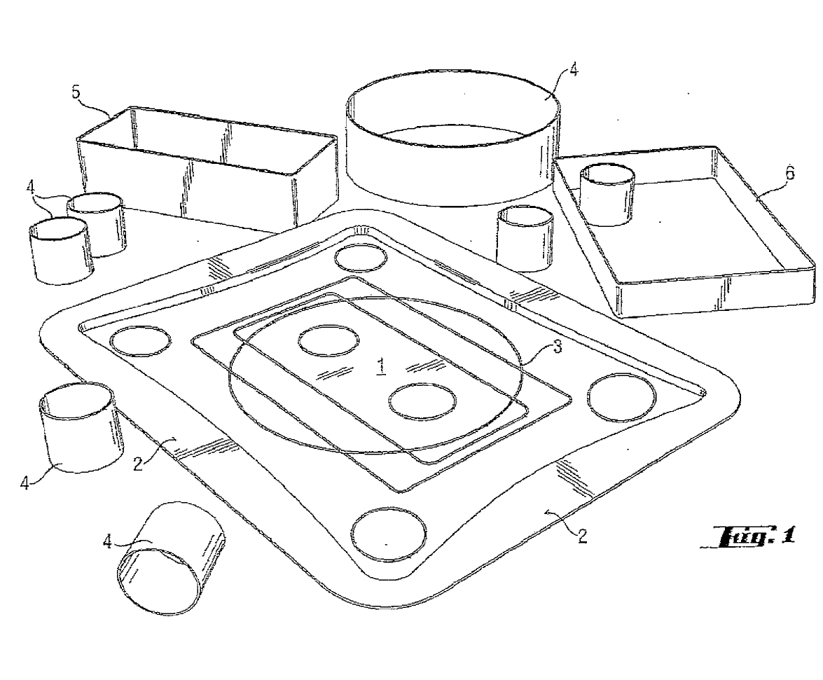

FIG. 1 shows a perspective illustration of a base plate according to the invention, having several associated limiting elements in a rigid embodiment, in a side view from the top;

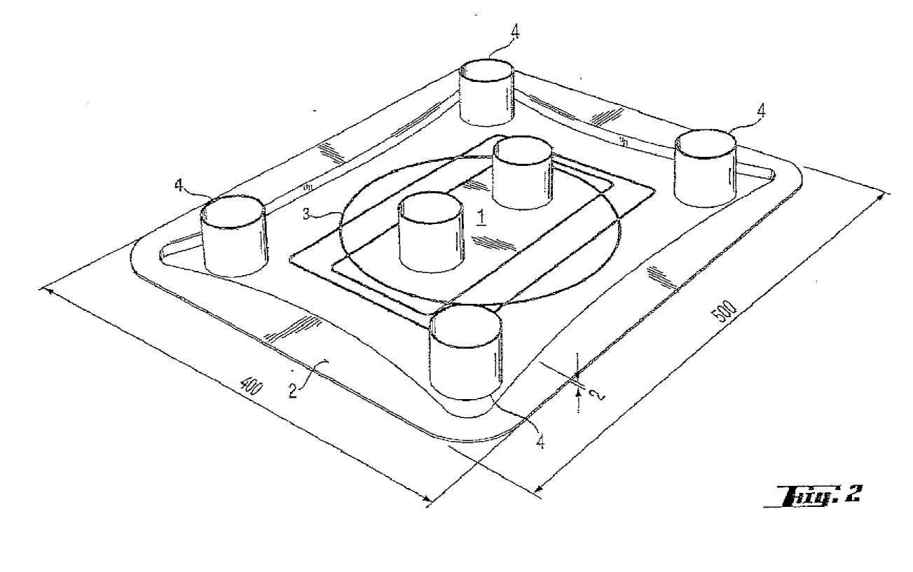

FIG. 2 shows a perspective illustration of a base plate according to the invention in which several limiting elements have been inserted, in a side view from the top;

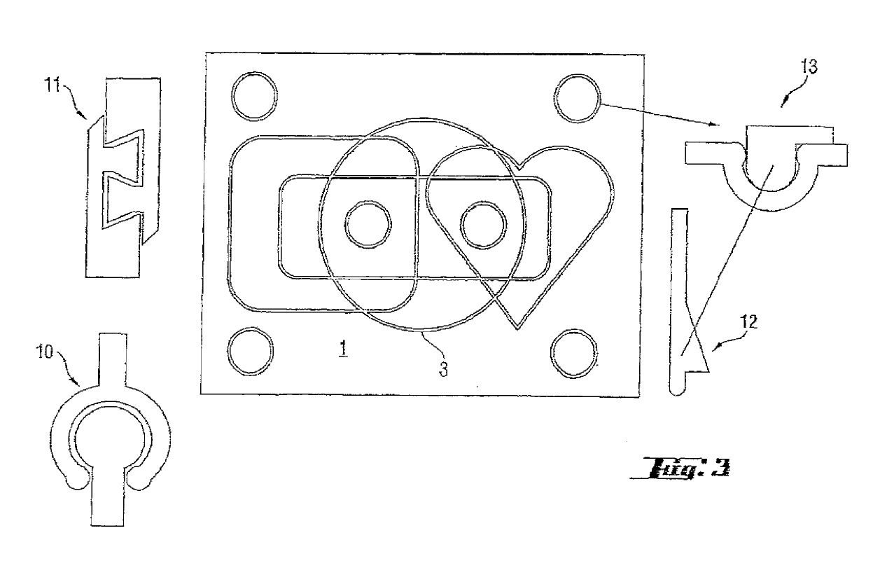

FIG. 3 schematically shows another base plate according to the invention, having different holding elements, and examples of connections of flexible limiting elements to one another and to the base plate;

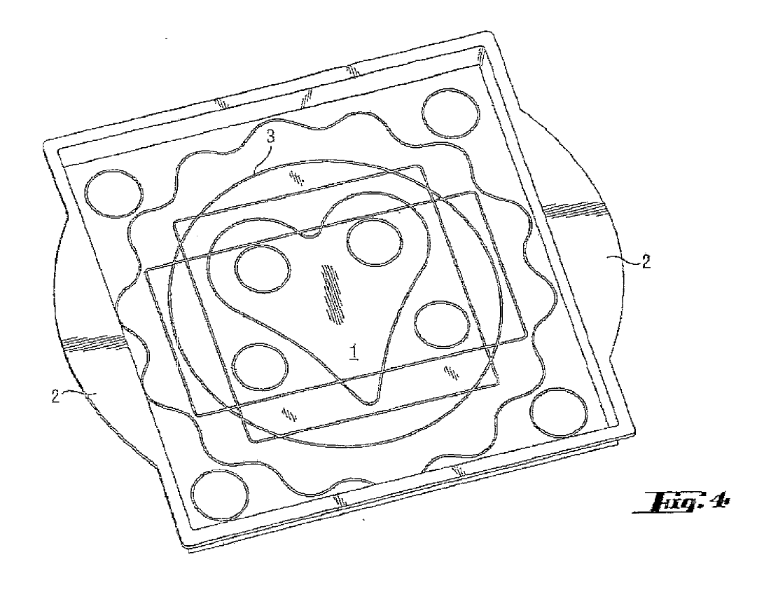

FIG. 4 shows a further perspective illustration of a base plate according to the invention, having the specified holding elements with a different geometric shape, in a side view from the top; and

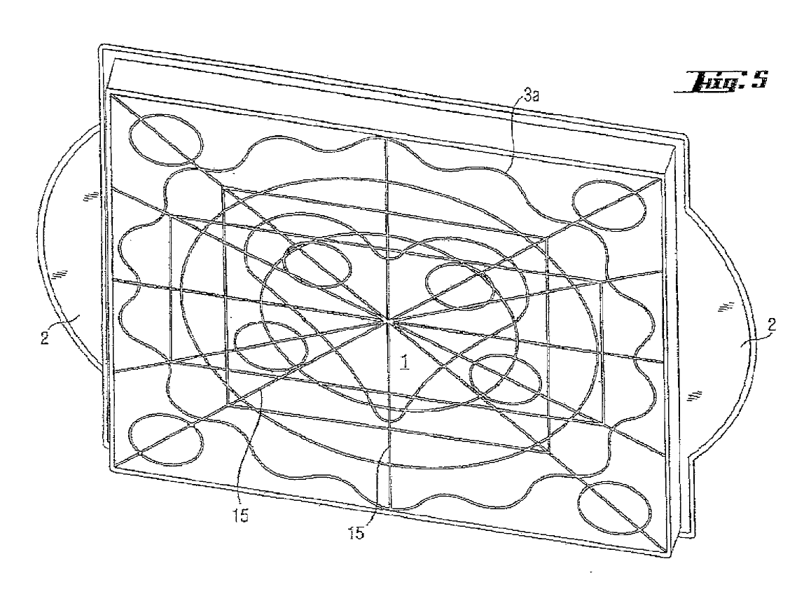

FIG. 5 shows a base plate according to FIG. 4, viewed from the back side.

This object is achieved by means of a container of the type described at the outset, having the characterizing features that it contains a base plate having an extension in one plane, and limiting elements which project from the plane and which are detachably connected to the base plate.

According to the invention, the base plate may be composed of a self-supporting material having sufficient mechanical strength and at the same time good thermal stability. Sufficient mechanical strength is necessary in order to place the prepared foods, for example baked goods, into the oven in the still uncooked state and to stationarily fix them in place. Thermal stability is understood as a matter of course, since the shape should not change during the cooking process in the oven, or even run the risk of being damaged by the effect of heat.

The base plate is therefore advantageously made of metal or ceramic. However, it may also be made of a thermally stable plastic. Examples of such thermally stable plastics are duroplasts such as silicones. However, thermoplastic plastics are known which are also suitable for high temperatures, for example polyesters, polyamides, polysulfones, polyimides, or polyetherimides. A further example of plastics with particular heat resistance is fully aromatic liquid crystal polymers (LCP), whose chemical composition is known from the prior art, and which in one special embodiment may be additionally reinforced with mineral fillers, glass fibers, carbon fibers, or combinations thereof.

The base plate is additionally provided with a plurality of holding or guiding elements as integral components, situated in the plane of the base plate, in the form of channels or grooves. These channels or grooves may have an elevated design on the back side of the base plate, in which case they have a stabilizing and reinforcing effect on the dimensional stability of the base plate. To increase this stabilizing effect, ribs or webs may be additionally provided on the back side of the base plate.

The holding or guiding elements themselves form self-contained curves which partially merge with one another or mutually overlap. The curves are used to connect the limiting elements to the base plate and to stationarily fix same in place during preparation of the food. The channels or grooves have a geometric design such that each of the rigid limiting elements, having a shape that is congruent with the channels or grooves, may be fixed therein by simple insertion.

On the other hand, if flexible limiting elements are used instead of rigid limiting elements, for proper shaping these flexible limiting elements are initially guided in a controlled manner by the geometric design of the channels or grooves, and are then stationarily fixed in place by insertion.

According to the invention, rigid as well as flexible limiting elements may be used as limiting elements. In the case of rigid limiting elements, these form self-contained frames on the base plate, congruent with the holding elements, which are open at the top and bottom and which may be easily inserted into the channels or grooves present in the base plate. The shape of such frames may be circular or polygonal, as well as heart-shaped or oval, and the frames together with the base plate then form a container which is open at the top and which is suitable for accommodating the prepared foods and is also used specifically for this purpose. For better stabilization, the limiting elements may have additional reinforcing elements such as webs or ribs.

In the case of rigid limiting elements, these may be made of metal or one of the thermally stable plastics referenced above. The limiting elements are preferably made of thermally stable plastic, since fixing to the base plate, and afterwards, the ability to demold for releasing the foods after preparation, is thus easier due to the better movability of the plastic compared to metal.

In comparison to rigid limiting elements, the use of one or more flexible limiting elements has the advantage of even greater flexibility in the variety of shapes, and at the same time even lower space requirements for storage in the household or bakery.

In the special case of a ring as the flexible limiting element, only two parts, the base plate and the ring, are sufficient when the circumferences of the individual shaping channels or grooves are all the same, and at the same time all correspond to the circumference of the limiting ring. In this case, from a purely theoretical standpoint practically any conceivable geometric shape may be produced with the lowest possible space requirements for storage, using only two individual parts.

Flexible limiting elements are preferably composed of crosslinked silicone polymer having adequate thermal stability. In contrast to rigid limiting elements, flexible limiting elements do not have to form a self-contained curve, but instead may be put together to form a closed curve by being provided with lateral connecting elements in the form of plug connections. In addition, zipper-like lateral connections of the flexible limiting elements may be provided, which are not addressed in greater detail in the description of the figures.

In this regard the use of flexible limiting elements allows a greater variety of shapes, since it is no no longer absolutely necessary to connect only a single limiting element to produce a closed curve laterally joined to itself; instead, multiple flexible limiting elements may be joined together to form geometric figures, each having a circumference that is a multiple of the lateral extension of a limiting element. At the same time, the plug connections have a reinforcing effect on the design of the containers thus formed together with the base plate.

The base plate according to the invention made of plastic is preferably manufactured by conventional techniques such as injection molding, thermoforming, hot pressing, injection-compression molding, low-pressure injection molding, or blow molding. The channels or grooves in the base plate are provided at the same time during manufacturing, using these techniques, or may be subsequently applied in a second manufacturing step. The shaping channels or grooves are advantageously provided as elevations on the back side of the base plate, as illustrated in FIG. 3, reference numeral 13. For better reinforcement, ribs or webs which provide the base plate with improved stability against deformation may be situated between a plurality of these elevations on the back side of the base plate.

The limiting elements made of plastic may also be manufactured using the same techniques of injection molding, thermoforming, hot pressing, injection-compression molding, low-pressure injection molding, or blow molding, which in principle are known to one skilled in the art.

At the location at which they are attached to the base plate the limiting elements form an angle of 90°, although other angles may be provided when particular sloped shapes, for example for baked goods, are desired.

In FIG. 1, reference numeral 1 denotes the base plate, which essentially extends in one plane. However, at the sides the base plate 1 has handles 2 which project out of the plane and provide a design which is easier to handle. Also illustrated on the base plate 1 are holding elements 3 which as channels in the form of self-contained curves extend on the top side of the base plate 1. FIG. 1 also shows various limiting elements 4, 5, and 6 having various circular (4) and quadrilateral (5 and 6) shapes.

Identical reference numerals have the same meaning in FIG. 2 as in FIG. 1. In particular, FIG. 2 also illustrates the base plate 1 as well as several circular limiting elements 4 perpendicularly applied thereto, for muffins. In this illustration the base plate 1 also has lateral handles 2 as well as several other holding elements 3 with different shapes. It is also shown in FIG. 2 that the length of a base plate 1 according to the invention, by way of example, may be five hundred (500) mm, and its width may be approximately four hundred (400) mm. The thickness of the base plate 1 may vary in a range of 1 to 5 mm; in the illustration in FIG. 2 the thickness is 2 mm.

FIG. 3 shows a further base plate 1 having holding elements 3 of a different shape on its top side. Two possibilities for lateral plug connections 10 and 11 of flexible limiting elements made of crosslinked silicone polymer are illustrated in a side view. In particular, the plug connection 11 has trapezoidal interlocking holders, which in the form of a zipper are placed one inside the other at one end and may then be joined together by simply running the fingers along same. Reference numerals 12 and 13 indicate possibilities for attaching the limiting elements 4, 5, 6 to the base plate 1, and possible lateral reinforcement 12 thereof.

FIG. 4 shows another base plate 1 having lateral handles 2 and holding elements 3 which extend in a different manner.

FIG. 5 shows the back view of the base plate 1 according to FIG. 4. The same reference numerals denote identical elements. The channels and grooves in the base plate 1 on the front side are present as elevations 3a on the back side. Also shown is stabilization of the shape of the base plate 1 by means of additional diagonally or transversely extending ribs and webs 15.

1. A modular container for the preparation of foods by cooking, characterized in that the modular container contains a base plate having an extension in one plane, and one or more limiting elements which project from the plane and which are detachably connected to the base plate.

2. The modular container according to claim 1, characterized in that the base plate is composed of a self-supporting material having sufficient mechanical strength and at the same time good thermal stability.

3. The modular container according to claim 1, characterized in that the base plate is made of metal, ceramic, or thermally stable plastic.

4. The modular container according to claim 1, characterized in that the base plate is additionally provided with a plurality of holding or guiding elements as integral components, situated in the plane of the base plate, in the form of channels or grooves, and the holding or guiding elements form self-contained curves which partially merge with one another or mutually overlap.

5. The modular container according to claim 1, characterized in that the modular container contains one or more rigid or flexible limiting elements as limiting elements.

6. The modular container according to claim 5, characterized in that rigid limiting elements represent self-contained frames on the base plate, congruent with the holding elements, which are open at the top and bottom and which are capable of being inserted into the channels or grooves present in the base plate.

7. The modular container according to claim 1, characterized in that the limiting elements have a shape that is circular, polygonal, heart-shaped, undulating, curved, or oval.

8. The modular container according to claim 5, characterized in that flexible limiting elements are preferably made of crosslinked silicone polymer having adequate thermal stability such that the limiting elements may be put together to form a closed curve, and are provided with lateral connecting elements in the form of plug connections.

9. The modular container according to claim 1, characterized in that reinforcing or stabilizing structures in the form of ribs and webs are affixed to the back side of the base plate.

10. A method for manufacturing the modular container for the preparation of foods of claim 1, the method comprising using injection molding, thermoforming, hot pressing, injection-compression molding, low-pressure injection molding, or blow molding.

11. (canceled)

12. The modular container according to claim 3, characterized in that the thermally stable plastic is duroplastic silicone or thermoplastic plastic.

13. The modular container according to claim 12, characterized in that the thermoplastic plastic is polyester, polyamide, polysulfone, polyimide, or polyetherimide.

14. The modular container according to claim 12, characterized in that the thermoplastic plastic is fully aromatic liquid crystal polymer.

15. The method according to claim 10, wherein the base plate is provided with a plurality of holding or guiding elements as integral components, situated in the plane of the base plate, in the form of channels or grooves, the channels or grooves being provided in the base plate in one production step during manufacture.

16. The method according to claim 15, wherein the base plate is provided with reinforcing or stabilizing structures in the form of ribs and webs affixed to the back side of the base plate, wherein the ribs and webs and the channels or grooves are provided in the base plate in one production step during manufacture.

17. A method for manufacturing the modular container of claim 1, wherein the base plate is provided with a plurality of holding or guiding elements as integral components, situated in the plane of the base plate, in the form of channels or grooves, the base plate further comprising reinforcing or stabilizing structures in the form of ribs and webs affixed to the back side of the base plate, the method characterized in that the base plate is first manufactured by injection molding, thermoforming, or blow molding, and in a second manufacturing step the channels or grooves as well as the ribs and webs are affixed to the top or bottom side of the base plate.
